(19) United States
(12) Patent Application Publication
(10) Pub. No.: US 2009/0274254 A1
(43) Pub. Date: Nov. 5, 2009

(54) DATA TRANSMITTING DEVICE AND DATA TRANSMITTING METHOD

(75) Inventor: Kyoko Hirata, Osaka (JP)

Correspondence Address: MCDERMOTT WILL & EMERY LLP, 600 13TH STREET, NW, WASHINGTON, DC, 20005-3096, US

(73) Assignee: PANASONIC CORPORATION, Osaka (JP)

(21) Appl. No.: 12/305,148

(22) PCT Filed: Jun. 11, 2007
(86) PCT No.: PCT/JP2007/061711

§ 371 Date: Dec. 16, 2008

(30) Foreign Application Priority Data
Jun. 16, 2006 (JP) 2006-167561

(51) Int. Cl. H04L 7/00

(52) U.S. Cl. 375/371

(57) ABSTRACT

The logic block 103 generates a serial-data signal DATA using a clock signal CLK generated by a clock generator 104. Then, a skew adjusting unit 111 adjusts a delay of the serial-data signal DATA based on the phase relationship between the clock signal CLK and the serial-data signal DATA, and outputs resultant serial-data signal DATA-SK and clock signal CLK to a FF circuit 112. The FF circuit 112 shapes the serial-data signal DATA-SK using the clock signal CLK, and transmits the resultant serial-data signal DATA-FF to outside the device. Accordingly, even if jitter of a clock signal is superimposed on a data signal after signal processing, the influence of this jitter is reduced, thus providing a data transmitting device capable of transmitting a data signal to outside the device with the influence of the jitter reduced.

### TECHNICAL FIELD

The present disclosure generally relates to data transmitting devices and data transmitting methods for digital data signals, and particularly relates to a data transmitting device and a data transmitting method for use in high-speed data transmission such as USB 2.0.

### BACKGROUND ART

Recent increase in data transmission amount requires higher speed of data transmission in data transmitting devices for transmitting data signals by connecting devices such as computers and digital television sets to their peripheral equipment.

Data transmitting devices conforming to transmission standards for serial interfaces, such as USB 2.0 disclosed in Non-Patent Document 1 and Serial ATA disclosed in Non-Patent Document 2, have currently achieved high data-transmission speed exceeding 400 Mbps. As disclosed in Non-Patent Document 3, interface specifications of physical-layer circuits or logical-layer circuits in the USB 2.0 described above are defined as UTMI (USB 2.0 Transceiver Macrocell Interface) specification.

Among serial interfaces capable of transmitting digital data signals at high speed, a data transmission speed of 480 Mbps has been achieved in a high-speed mode of the USB 2.0. To generate a data signal to be transmitted at this data transmission speed, a logic block (described later) operates at a clock frequency of 480 MHz, i.e., with a clock signal at a high speed of 2.08 nsec per one clock and generates such a data signal. In this manner, the increase in data transmission amount involves an increase in the speed of a clock signal used in signal processing of a data transmitting device.

Examples of conventional data transmitting devices include a data transmitting device shown in FIG. 16.

In FIG. 16, signal control of a USB 2.0 is performed using a transceiver macrocell 201 as a physical-layer circuit and a USB control block 207 as a logical-layer circuit, based on specifications defined by the UTMI specification. The transceiver macrocell 201 includes a transceiver block 202, a logic block 203, and a clock generator 204 for generating a clock signal CLK at 480 MHZ. The transceiver block 202 includes a driver 205 and a receiver 206.

Hereinafter, it will be described how the data transmitting device shown in FIG. 16 operates.

First, a parallel-data signal P-DATA to be transmitted by a USB is transferred from the USB control block 207 to the logic block 203. The logic block 203 performs signal processing on this parallel-data signal P-DATA, converts the parallel-data signal P-DATA into a serial-data signal DATA by using the clock signal CLK generated by the clock generator 204, and transmits the serial-data signal DATA to the transceiver block 202. Then, the transceiver block 202 drives a transmission cable at a signal level and an impedance both satisfying the USB 2.0 standard, and transmits the serial-data signal DATA to outside the device.

Non-Patent Document 1: Compaq Computer Corporation and other six companies, “Universal Serial Bus Specification” [online], [retrieved on Apr. 27, 2000]. Retrieved from the Internet: <URL: http://www.usb.org/developers/docs/usb_{—}20.zip>

Non-Patent Document 2: Dell Computer Corporation and other four companies, “Serial ATA II: Electrical Specification” [online], pp. 30-32, [retrieved on May 26, 2004]. Retrieved from the Internet: <URL: http://www.sata-io.org/docs/PHYii%20Spec%20Rev%201_{—}0%20052604.pdf>

Non-Patent Document 3: Wes Talarek, “USB 2.0 Transceiver and Macrocell Tester (T&MT) Interface Specification” [online], Intel Corporation, [retrieved on Apr. 4, 2001]. Retrieved from the Internet: <URL: http://www.intel.com/technology/usb/download/transceiverandmacrocelltestv0_{—}1_{—}2.pdf>

### DISCLOSURE OF INVENTION

### Problems that the Invention is to Solve

In the conventional data transmitting device and data transmitting method illustrated in FIG. 16, however, the logic block 203 performs high-speed signal processing by repeatedly changing a signal flowing therein between “High” and “Low” in synchronization with a high-speed clock signal, thus causing fluctuations in a power supply or a ground in the logic block 203. This causes jitter in a clock signal transmitted through a clock path in the logic block 203. The jitter of this clock signal is superimposed on a serial-data signal DATA subjected to signal processing, resulting in deterioration of the signal quality.

FIG. 17(A) is a block diagram illustrating a configuration of a main portion of a clock path in the logic block 203. FIG. 17(B) is a diagram showing waveforms of a clock signal transmitted through the clock path.

In FIGS. 17(A) and 17(B), when a clock signal CLK-IN is input to a clock path, this clock signal CLK-IN is transmitted through the clock path while being affected by fluctuations in a power supply voltage VDD and a ground voltage GND on which noise has been superimposed. These fluctuations change the rising time or trailing time of the clock signal to disturb the signal waveform, resulting in that a clock signal CLK-OUT on which jitter is interposed is output from the clock path.

In high-speed data transmission at, for example, 480 Mbps, only low jitter greatly affects the signal quality. For example, even in a case where only ±100 psec of jitter of a clock signal is superimposed on a serial-data signal DATA, an eye pattern of a serial-data signal DATA output from the logic block 203 deteriorates by about 10%. Accordingly, at some levels of jitter of a clock signal generated in the logic block 203, the serial-data signal DATA deviates from transmission specifications and might fail to be transmitted outside the device.

FIG. 18(A) is a diagram showing waveforms of signals during signal processing using a flip-flop circuit. FIG. 18(B) is a diagram showing an eye pattern of an output data signal.

In FIG. 18(A), an input clock signal CLK-IN and an input data signal DATA-IN are input to a flip-flop circuit. The flip-flop circuit performs signal processing on the input data signal DATA-IN by using the input clock signal CLK-IN, thereby outputting an output data signal DATA-OUT.

At this time, jitter is superimposed on the input clock signal CLK-IN. When the signal processing is performed on the input data signal DATA-IN in synchronization with the input clock signal CLK-IN, the jitter of the input clock signal CLK-IN is also superimposed on the output data signal DATA-OUT after the signal processing. Consequently, as shown in FIG. 18(B), an opening in the eye pattern of the output data signal DATA-OUT becomes smaller so that the data quality of the output data signal DATA-OUT deteriorates.

It is therefore an object of this disclosure to provide a data transmitting device and a data transmitting method with which, in a data transmitting device including a clock generator for generating a clock signal, a logic block for performing signal processing on a data signal, and a data driver for outputting the data signal to a transmission system, even when jitter of the clock signal generated by the logic block is superimposed on the data signal after the signal processing, the data signal is transmitted from the data driver to outside the device with the influence of jitter of the clock signal reduced.

### Means of Solving the Problems

To achieve the above-mentioned object, a presently-disclosed data transmitting device including a clock generator for generating a clock signal, a logic block for performing signal processing on a data signal, and a data driver for outputting the data signal to a transmission system employs a configuration in which a waveform shaping circuit is newly provided in the data driver so that the waveform of the processed data signal subjected to the signal processing of the logic block is shaped by using the clock signal generated by the clock generator.

Specifically, a data transmitting device according to this disclosure is characterized by including: a clock generator for generating a clock signal; a logic block for performing signal processing on a received input data signal by using the clock signal, thereby generating a processed data signal; a data driver for outputting the processed data signal to a transmission system. The data driver includes: a skew adjusting unit for receiving the clock signal and the processed data signal, and adjusting skew between the clock signal and the processed data signal based on a phase relationship between these signals; a flip-flop circuit for shaping the processed data signal from the skew adjusting unit by using the clock signal from the skew adjusting unit.

The data transmitting device is characterized in that the skew adjusting unit receives the clock signal used for the signal processing of the logic block and, based on this clock signal, adjusts skew between the clock signal and the processed data signal.

The data transmitting device is characterized by further including a data level converter for converting a signal level of the processed data signal from the logic block into a power supply voltage level of the data driver.

The data transmitting device is characterized by further including a clock level converter for converting a signal level of the clock signal used for the signal processing of the logic block into a power supply voltage level of the data driver.

The data transmitting device is characterized in that the skew adjusting unit includes a data delay circuit for delaying the processed data signal from the logic block.

The data transmitting device is characterized in that the skew adjusting unit includes a clock delay circuit for delaying the clock signal from the clock generator.

The data transmitting device is characterized in that the skew adjusting unit includes a delay-time adjusting circuit for adjusting a delay time of at least one of the data delay circuit and the clock delay circuit, and that the delay-time adjusting circuit adjusts the delay time of at least one of the data delay circuit and the clock delay circuit based on a phase relationship between the processed data signal from the logic block and the clock signal from the clock generator.

The data transmitting device is characterized in that the skew adjusting unit includes a delay-time adjusting circuit for adjusting a delay time of at least one of the data delay circuit and the clock delay circuit, and that the delay-time adjusting circuit adjusts the delay time of at least one of the data delay circuit and the clock delay circuit based on a phase relationship among the processed data signal from the logic block, the clock signal from the clock generator, and the clock signal used for the signal processing of the logic block.

The data transmitting device is characterized in that the skew adjusting unit includes a delay-start control circuit for controlling a start of the delay time adjustment by the delay-time adjusting circuit.

The data transmitting device is characterized in that the skew adjusting unit includes a delay-time storage circuit for storing an amount of adjustment of the delay time by the delay-time adjusting circuit.

The data transmitting device is characterized in that the skew adjusting unit includes a fixed-time delay circuit for delaying, by a given time, the adjustment of the delay time by the delay-time adjusting circuit.

The data transmitting device is characterized in that the clock generator includes a multiphase clock generator for generating multiphase clock signals, that the skew adjusting unit selects a single-phase clock signal from the multiphase clock signals based on the processed data signal from the logic block, and that the flip-flop circuit shapes the processed data signal from the skew adjusting unit by using the single-phase clock signal.

The data transmitting device is characterized in that the clock generator includes a multiphase clock generator for generating multiphase clock signals, that the skew adjusting unit selects a single-phase clock signal from the multiphase clock signals based on the processed data signal from the logic block and the clock signal used for the signal processing of the logic block, and that the flip-flop circuit shapes the processed data signal from the skew adjusting unit by using the single-phase clock signal.

A data transmitting method according to this disclosure is characterized by including: a clock generation step of generating a clock signal; a data signal processing step of performing signal processing on a received input data signal by using the clock signal and of generating a processed data signal; a skew adjustment step of adjusting skew between the clock signal and the processed data signal based on a phase relationship between these signals; a data processing step of shaping the processed data signal in the skew adjustment step by using the clock signal in the skew adjustment step; and a data drive step of outputting the processed data signal shaped in the data processing step to a transmission system.

With the foregoing configuration, according to this disclosure, even when jitter of a clock signal generated in the logic block is superimposed on a processed data signal, the flip-flop circuit shapes the processed data signal by using a clock signal generated by the clock generator and having no jitter. Consequently, a processed data signal whose signal quality has deteriorated by jitter is shaped into a data signal within a range satisfying specifications and the data signal is transmitted. The skew adjusting unit adjusts the setup time and the hold time of signals to be input to the flip-flop circuit and shapes a processed data signal, resulting in preventing a loss of data.

### EFFECTS OF THE INVENTION

As described above, according to this disclosure, in a data driver, a processed signal whose signal quality has deteriorated by superimposition thereon of jitter of a clock signal generated in a logic block is shaped so that a data signal within a range defined by transmission specifications is generated and transmitted. In addition, the setup time and hold time for signals input to a flip-flop circuit are satisfied. As a result, a data signal in which a loss of data is prevented is transmitted.

### BRIEF DESCRIPTION OF DRAWINGS

FIG. 1 is a block diagram illustrating an overall configuration of a data transmitting device according to a first embodiment of this disclosure.

FIG. 2 is a diagram showing signal waveforms in a skew adjusting unit in the data transmitting device of the first embodiment.

FIG. 3 is a diagram showing signal waveforms in a FF circuit in the data transmitting device of the first embodiment.

FIG. 4 is a block diagram illustrating an overall configuration of the skew adjusting unit in the data transmitting device of the first embodiment.

FIG. 5 is a diagram showing signal waveforms in an internal circuit of the skew adjusting unit.

FIG. 6 is a block diagram illustrating an overall configuration of a data transmitting device according to a second embodiment of this disclosure.

FIG. 7 is a block diagram illustrating an overall configuration of a data level shifter in the data transmitting device of the second embodiment.

FIG. 8 is a block diagram illustrating an overall configuration of a data transmitting device according to a third embodiment of this disclosure.

FIG. 9 is a block diagram illustrating an overall configuration of a data transmitting device according to a fourth embodiment of this disclosure.

FIG. 10 is a block diagram illustrating an overall configuration of a skew adjusting unit in the data transmitting device of the fourth embodiment.

FIG. 11 is a diagram showing signal waveforms in an internal circuit of the skew adjusting unit.

FIG. 12 is a block diagram illustrating an overall configuration of a data transmitting device according to a fifth embodiment of this disclosure.

FIGS. 13(A) and 13(B) are waveform diagrams schematically showing selection of a single-phase clock in a skew adjusting unit in the data transmitting device of the fifth embodiment.

FIG. 14 is a block diagram illustrating an overall configuration of a skew adjusting unit in the data transmitting device of the fifth embodiment.

FIG. 15 is a diagram showing signal waveforms in an internal circuit of the skew adjusting unit.

FIG. 16 is a block diagram illustrating an overall configuration of a conventional data transmitting device.

FIG. 17(A) is a block diagram illustrating a configuration of a main portion of a clock path in a logic block. FIG. 17(B) is a diagram showing waveforms of a clock signal transmitted through the clock path.

FIG. 18(A) is a diagram showing waveforms of signals during signal processing using a flip-flop circuit. FIG. 18(B) is a diagram showing an eye pattern of an output data signal.

### DESCRIPTION OF NUMERALS

CLK clock signal
CLK1.2 clock signal for a 1.2 V system
CLK3.3 clock signal for a 3.3 V system
CLK-LB clock signal used for signal processing of logic block
CLK-LS clock signal after level shift
P-DATA parallel-data signal (input data signal)
DATA serial-data signal (processed data signal)
DATA-FF serial-data signal after shaping
DATA-LS serial-data signal after level shift
SP-CLK single-phase clock signal
MP-CLK multiphase clock signal

### BEST MODE FOR CARRYING OUT THE INVENTION

Hereinafter, data transmitting devices and data transmitting methods according to embodiments of this disclosure will be described with reference to the drawings.

### Embodiment 1

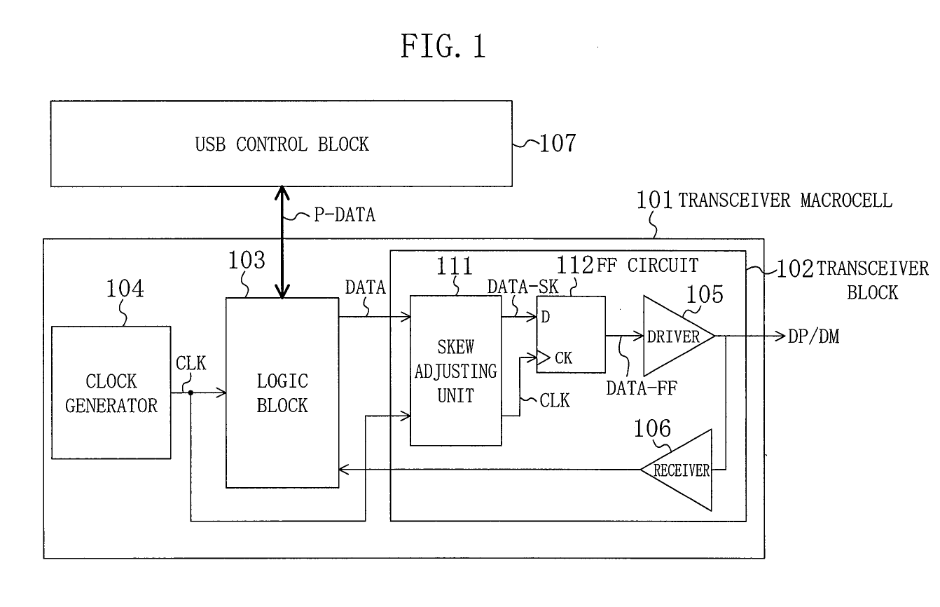

FIG. 1 is a block diagram illustrating an overall configuration of a data transmitting device according to a first embodiment of this disclosure.

In FIG. 1, signal control of a USB 2.0 is performed by using a transceiver macrocell 101 as a physical-layer circuit and a USB control block 107 as a logical-layer circuit. The transceiver macrocell 101 includes a transceiver block (data driver) 102, a logic block 103, and a clock generator 104. The transceiver block 102 includes a skew adjusting unit 111, a flip-flop circuit (hereinafter, referred to as a FF circuit) 112, a driver 105, and a receiver 106.

It is now specifically described how the data transmitting device illustrated in FIG. 1 operates.

First, a parallel-data signal (input data signal) P-DATA to be transferred by a USB is transferred from the USB control block 107 to the logic block 103. The logic block 103 performs signal processing on this parallel-data signal P-DATA by using a clock signal CLK generated by the clock generator 104, thereby generating a serial-data signal (processed data signal) DATA and transferring the serial-data signal DATA to the transceiver block 102. At this time, jitter occurs in the supplied clock signal because of high-speed signal processing or noise in the logic block 103, and the jitter of this clock signal is superimposed on the serial-data signal DATA.

Next, the serial-data signal DATA generated by the logic block 103 and a clock signal CLK generated by the clock generator 104 and having no jitter are input to the skew adjusting unit 111. This skew adjusting unit 111 adjusts a delay of the serial data DATA based on a phase relationship between the clock signal CLK and the serial-data signal DATA and outputs a serial-data signal DATA-SK after the delay adjustment and the clock signal CLK to the FF circuit 112.

The skew adjusting unit 111 is designed to meet the setup time and hold time of the FF circuit 112 in consideration of the maximum and minimum values of delay time of signal transmission in the logic block 103 under any working condition. The skew adjusting unit 111 adjusts skew between the clock signal CLK and the serial-data signal DATA-SK.

By using this clock signal CLK with low jitter, the FF circuit 112 shapes the serial-data signal DATA-SK after the delay adjustment, thereby reducing jitter of the serial-data signal DATA-SK.

Then, a serial-data signal DATA-FF whose jitter has been reduced is transferred to outside the device by driving a transmission cable with the driver 105 at a signal level and an impedance both satisfying the USB 2.0 standard.

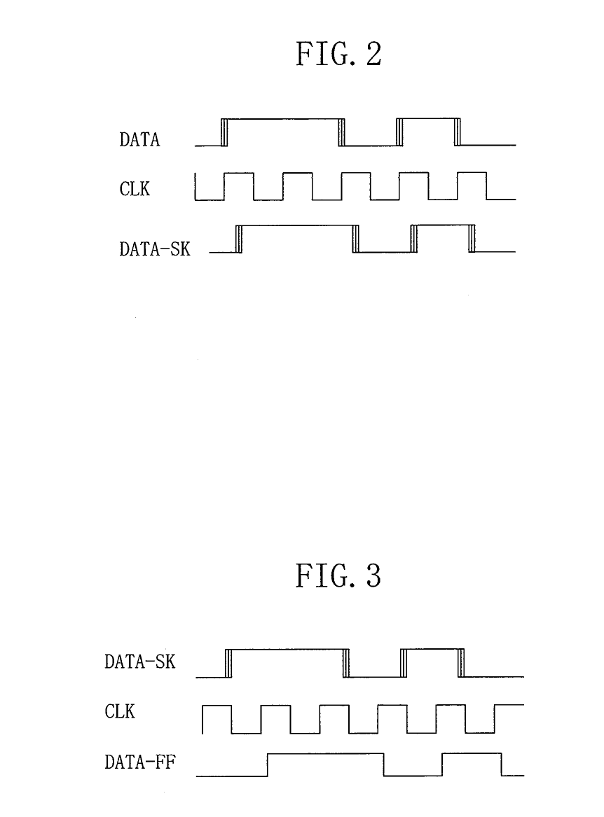

FIG. 2 is a diagram showing signal waveforms in the skew adjusting unit 111 of the data transmitting device of this embodiment.

In FIG. 2, the skew adjusting unit 111 receives a serial-data signal DATA and a clock signal CLK having no jitter. The serial-data signal DATA is a data signal on which jitter is superimposed.

For example, in shaping an input serial-data signal DATA-SK at a rising edge of a clock signal CLK in the FF circuit 112, if an edge of the serial-data signal DATA-SK and the rising edge of the clock signal do not meet the setup time and hole time of the FF circuit 112, the serial-data signal DATA-SK cannot be accurately shaped. To prevent this, the skew adjusting unit 111 delays an input serial-data signal DATA based on a phase relationship between the clock signal CLK and the serial-data signal DATA to adjust skew between the clock signal CLK and the serial-data signal DATA-SK.

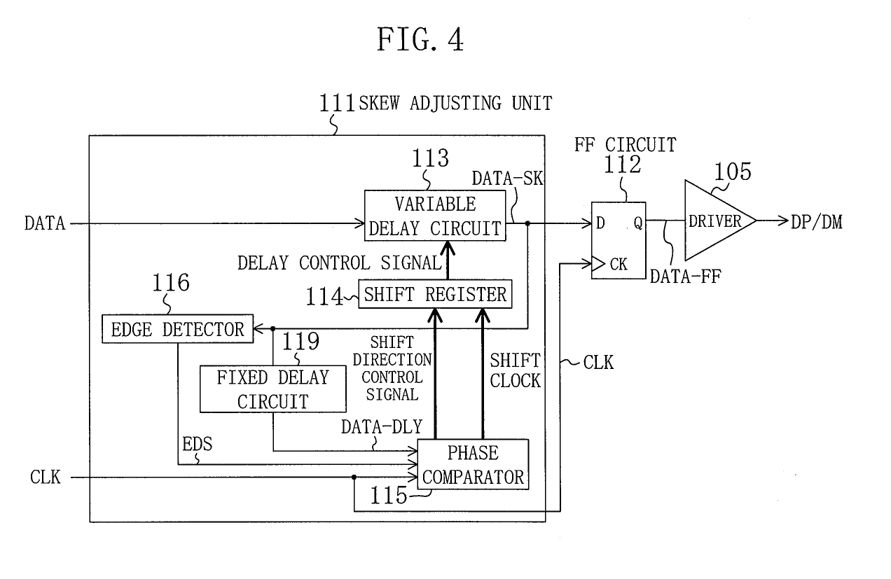

FIG. 3 is a diagram showing signal waveforms in the FF circuit 112 of the data transmitting device of this embodiment.

In FIG. 3, the FF circuit 112 receives a serial-data signal DATA-SK and a clock signal CLK. In synchronization with rising edges of the clock signal CLK, the FF circuit 112 shapes the serial-data signal DATA-SK, thereby outputting a serial-data signal DATA-FF having reduced jitter.

As described above, in this embodiment, the FF circuit 112 is provided in the transceiver block 102, a serial-data signal DATA-SK with jitter and a clock signal CLK with low jitter are input to the FF circuit 112, and the serial-data signal DATA-SK is shaped by using the clock signal CLK, thereby reducing the jitter of the serial-data signal DATA-SK. In this manner, an eye pattern of a serial-data signal DATA-FF to be sent to the outside is improved.

In addition, the skew adjusting unit 111 is provided in the transceiver block 102 to adjust skew between the serial-data signal DATA generated by the logic block 103 and the clock signal CLK. Accordingly, in shaping the serial-data signal DATA-SK by using the clock signal CLK, the setup time and hold time of the FF circuit 112 are satisfied so that a loss of data is prevented.

In this embodiment, the skew adjusting unit 111 in the transceiver block 102 adjusts a delay of the serial-data signal DATA. Alternatively, it is, of course, sufficient that a delay of at least one of the serial-data signal DATA and the clock signal CLK input to the skew adjusting unit 111 is adjusted.

When edges of the data signal DATA and edges of the clock signal CLK meet the setup time and hold time of the FF circuit 112, it is possible for the FF circuit 112 to appropriately shape the data signal DATA without using the skew adjusting unit 111.

FIG. 4 is a block diagram illustrating an example of an overall configuration of the skew adjusting unit 111 in the data transmitting device of this embodiment. The internal configuration of the skew adjusting unit 111 is not limited to the configuration illustrated in FIG. 4 and, of course, may be any configuration.

In FIG. 4, reference numeral 113 denotes a variable delay circuit (data delay circuit), reference numeral 114 denotes a shift register (delay-time storage circuit), reference numeral 115 denotes a phase comparator (delay-time adjusting circuit), reference numeral 116 denotes an edge detector (delay-start control circuit), and reference numeral 119 denotes a fixed delay circuit (fixed-time delay circuit).

A serial-data signal DATA supplied to the skew adjusting unit 111 is subjected to delay adjustment in the variable delay circuit 113. A serial-data signal DATA-SK after the delay adjustment is supplied to the fixed delay circuit 119, the edge detector 116, and the FF circuit 112. Then, the serial-data signal DATA-SK supplied to the fixed delay circuit 119 is input to the phase comparator 115 after a lapse of a certain delay time. Upon input of an edge detection signal EDS output in data transition of a serial-data signal DATA-SK, the phase comparator 115 performs phase comparison between a serial-data signal DATA-DLY and a clock signal CLK. Based on the phase relationship between these signals DATA-DLY and CLK, a delay time of the variable delay circuit 113 is input to the shift register 114 as a shift direction control signal and a shift clock. The shift register 114 stores the delay time of the variable delay circuit 113 supplied from the phase comparator 115. By adjusting this delay time, the delay of the serial-data signal DATA is adjusted, thus adjusting a delay time of a data line supplied to the FF circuit 112 and the edge detector 116.

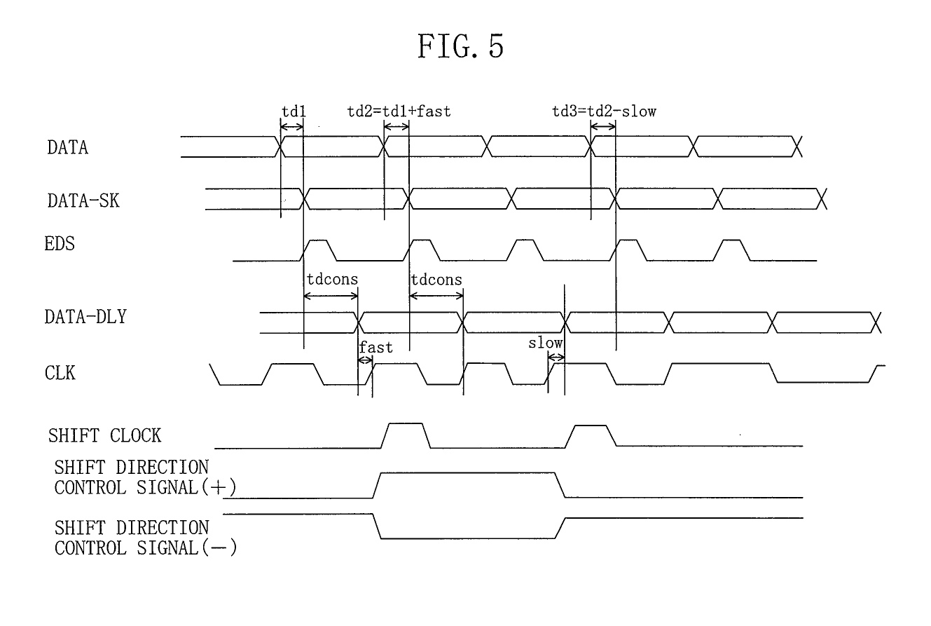

FIG. 5 is a diagram showing signal waveforms in an internal circuit of the skew adjusting unit 111.

Referring now to FIGS. 4 and 5, principles of operation of the skew adjusting unit 111 are described.

First, in the variable delay circuit 113, a delay in a delay amount td1 is given to a serial-data signal DATA, and a serial-data signal DATA-SK whose delay has been adjusted is input to the edge detector 116 and the fixed delay circuit 119.

Next, the edge detector 116 detects a rising edge of the serial-data signal DATA-SK and outputs an edge detection signal EDS. The edge detection signal EDS is input to the phase comparator 115 so that the phase comparator 115 is activated.

In the fixed delay circuit 119, a delay in a delay amount tdcons is given to the serial-data signal DATA-SK. The resultant serial-data signal DATA-DLY is input to the phase comparator 115.

The phase comparator 115 compares a rising edge of the serial-data signal DATA-DLY which has passed through the variable delay circuit 113 and the fixed delay circuit 119 and a rising edge of a clock signal CLK. Based on the comparison result, the phase comparator 115 determines the direction of the shift register 114 and generates a shift clock. At this time, if these signals DATA-DLY and CLK are in the same phase, no shift clock is generated.

If the rising edge of the serial-data signal DATA-DLY is ahead of the rising edge of the clock signal CLK by a time difference fast, the delay amount in the variable delay circuit 113 is increased by an amount corresponding to fast. If the rising edge of the serial-data signal DATA-DLY is behind the rising edge of the clock signal CLK by a time difference slow, the delay amount in the variable delay circuit 113 is reduced by an amount corresponding to slow so that the phase at the rising edge of the clock signal CLK and the phase at the rising edge of the serial-data signal DATA-DLY are matched.

The phases at the rising edges of the serial-data signal DATA-DLY and the clock signal CLK are matched by repeating the above-described comparison between these signals CLK and DATA-DLY so that the phase difference between the clock signal CLK and the serial-data signal DATA-SK input to the subsequent FF circuit 112 becomes equal to the fixed delay amount tdcons in the fixed delay circuit 119. In view of this, this fixed delay amount tdcons is set at an optimum value for latching a serial data signal, thus securing the setup time of data.

In this embodiment, the variable delay circuit 113 is used to adjust a delay time of the serial-data signal DATA in the logic block 103. Alternatively, the adjustment of this delay time may be performed on the clock signal CLK input to the skew adjusting unit 111.

Since the serial-data signal DATA-DLY to be subjected to phase comparison has a jitter component, this serial-data signal DATA-DLY is supplied to the phase comparator 115 by way of a circuit for filtering an influence of jitter so that the delay time is precisely adjusted.

### Embodiment 2

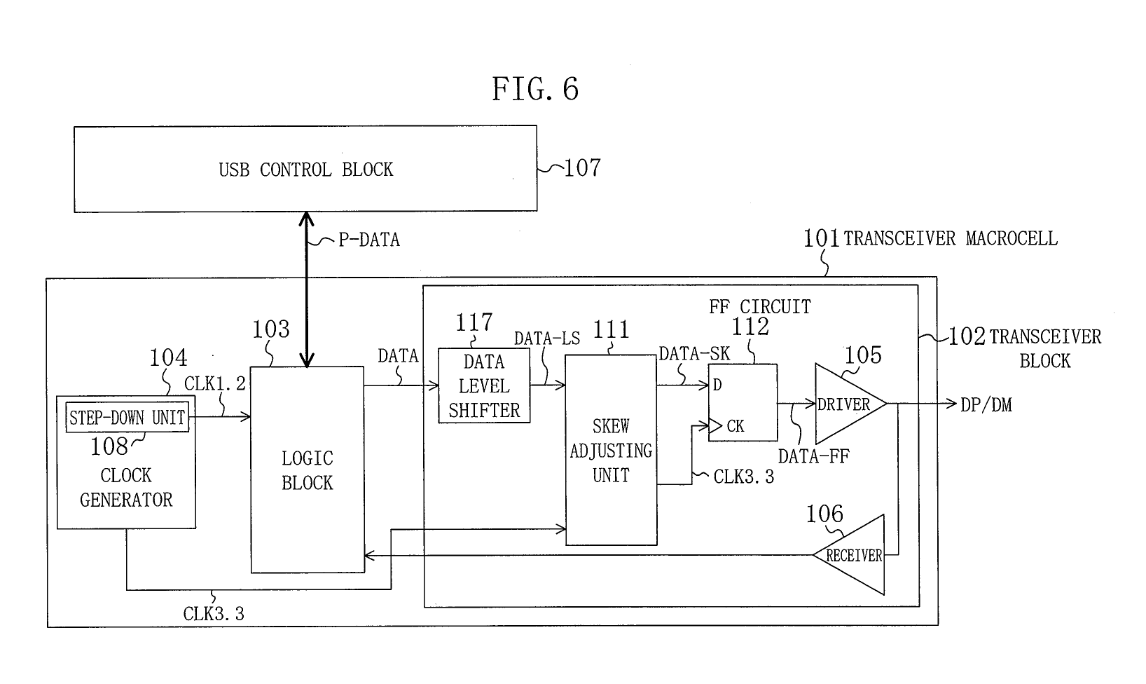

FIG. 6 is a block diagram illustrating an overall configuration of a data transmitting device according to a second embodiment of this disclosure.

The data transmitting device of this embodiment is different from the data transmitting device of the first embodiment illustrated in FIG. 1 only in that a data level shifter (data level converter) 117 is provided in a transceiver block 102 and a step-down unit 108 is provided in a clock generator 104. The other part of the configuration is the same as that of the first embodiment, and description thereof is omitted.

In FIG. 6, the logic block 103 is a digital circuit and operates at a power supply voltage of 1.2V. The transceiver block 102 is an analog circuit and operates at a power supply voltage of 3.3V. In view of this, in this embodiment, a clock signal CLK3.3 for the 3.3 V system generated by the clock generator 104 is supplied to the skew adjusting unit 111 and a clock signal CLK 1.2V for the 1.2 V system generated by the step-down unit 108 in the clock generator 104 is supplied to the logic block 103.

The data level shifter 117 in the transceiver block 102 receives a serial-data signal DATA from the logic block 103. Since this serial-data signal DATA is a data signal of the 1.2 V system, the data level shifter 117 shifts the signal level of the serial-data signal DATA to the level of the 3.3 V system which is a power supply voltage level of the transceiver block 102, and outputs the resultant serial-data signal DATA-LS to the skew adjusting unit 111. Accordingly, the serial-data signal DATA-LS and the clock signal CLK3.3 input to the skew adjusting unit 111 are both signals of the 3.3 V system.

Then, the skew adjusting unit 111 adjusts a delay of the serial-data signal DATA-LS, thereby adjusting skew between the serial-data signal DATA-SK and the clock signal CLK. The FF circuit 112 shapes the serial-data signal DATA-SK.

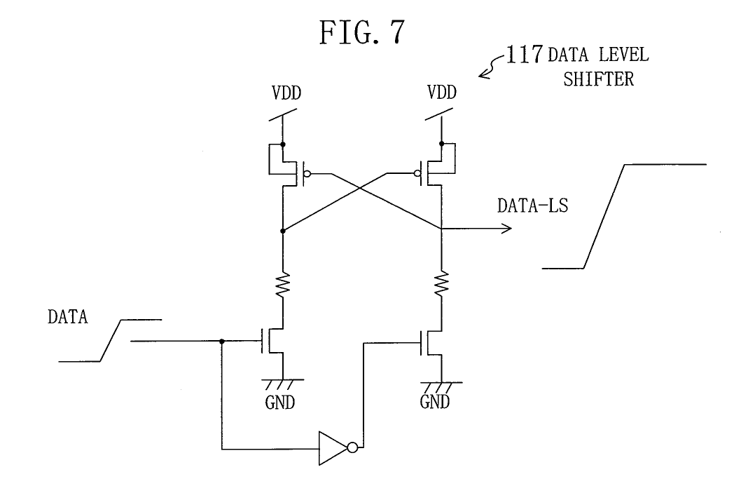

FIG. 7 is a block diagram illustrating an overall configuration of the data level shifter 117 in the data transmitting device of this embodiment.

The data level shifter 117 illustrated in FIG. 7 increases the signal level of the input serial-data signal DATA for the 1.2 V system to the level of the serial-data signal DATA-LS for the 3.3 V system, thus increasing the amplitude of the serial-data signal DATA-LS to be input to the skew adjusting unit 111.

As described above, in this embodiment, the data level shifter 117 is provided in the transceiver block 102 to convert the signal level of the serial-data signal DATA into the level of the serial-data signal DATA-LS of the 3.3 V system which is the power supply voltage level of the transceiver block 102. This serial-data signal DATA-LS and the serial-data signal DATA-SK based on the serial-data signal DATA-LS are input to the skew adjusting unit 111 and the FF circuit 112, respectively. Accordingly, an input voltage is shifted to a desired voltage so that the signal voltage levels of signals supplied to the skew adjusting unit 111 and the FF circuit 112 are matched, resulting in facilitating skew adjustment.

In this embodiment, the data level shifter 117 is provided in the transceiver block 102. Alternatively, the data level shifter 117 may, of course, be provided outside the transceiver block 102, e.g., in the transceiver macrocell 101.

### Embodiment 3

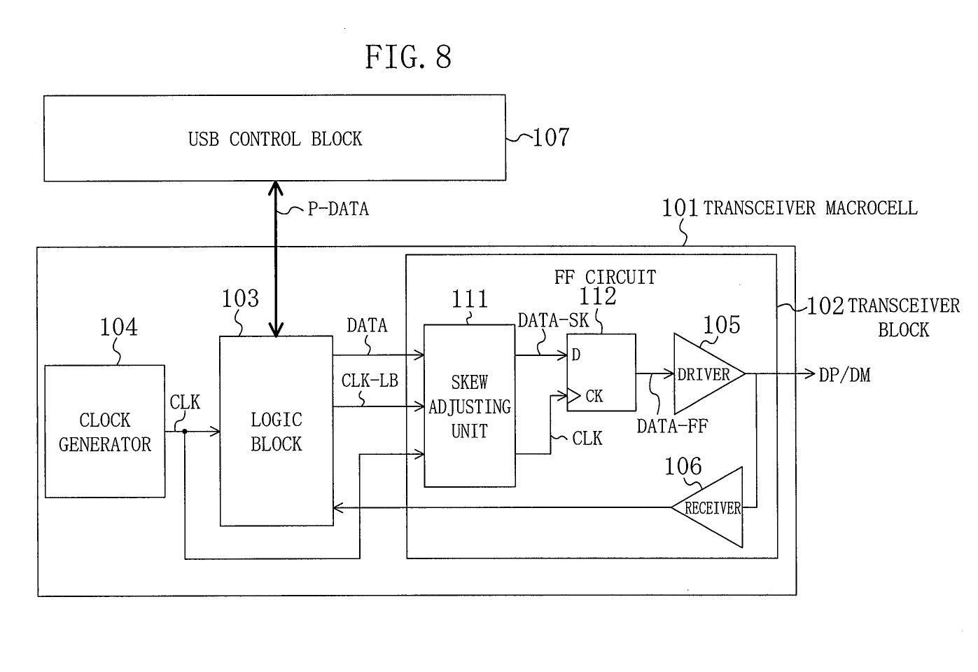

FIG. 8 is a block diagram illustrating an overall configuration of a data transmitting device according to a third embodiment of this disclosure.

The data transmitting device of this embodiment is different from the data transmitting device of the first embodiment illustrated in FIG. 1 only in that a serial-data signal DATA from a logic block 103, a clock signal CLK from a clock generator 104, and a clock signal CLK-LB used for signal processing of the logic block 103 are supplied to a skew adjusting unit 111. The other part of the configuration is the same as that of the first embodiment, and description thereof is omitted.

The skew adjusting unit 111 adjusts a delay of the serial-data signal DATA by using the clock signal CLK, the serial-data signal DATA, and the clock signal CLK-LB used for signal processing of the logic block 103.

The skew adjusting unit 111 illustrated in FIG. 4 compares the phases between the clock signal CLK-LB used for signal processing of the logic block 103 and the clock signal CLK from the clock generator 104, thereby adjusting a delay of the serial-data signal DATA from the logic block 103. The resultant serial-data signal DATA-SK after the delay adjustment is output to the FF circuit 112 to be shaped.

As described above, in this embodiment, a delay of the serial-data signal DATA is adjusted based on the clock signal CLK-LB used for signal processing of the logic block 103. Thus, the use of the clock signal CLK-LB, which is a cause of jitter of the serial-data signal DATA, allows skew between the serial-data signal DATA-SK and the clock signal CLK supplied to the FF circuit 112 to be accurately adjusted.

In addition, in the first embodiment, the skew adjusting unit 111 performs skew adjustment by using the serial-data signal DATA having a signal waveform in which “High” and “Low” appear at random so that it is impossible to perform phase comparison at every cycle of the clock signal CLK. On the other hand, in the third embodiment, phase comparison is performed by using the clock signal CLK-LB having a signal waveform in which “High” and “Low” periodically appear, thereby making it possible to perform phase comparison at every cycle of the clock signals CLK-LB and CLK.

In this embodiment, the skew adjusting unit 111 adjusts a delay of the serial-data signal DATA from the logic block 103 based on the clock signal CLK from the clock generator 104 and the clock signal CLK-LB used for signal processing of the logic block 103. Alternatively, the delay adjustment may, of course, be performed based on the two clock signals CLK and CLK-LB and the serial-data signal DATA.

### Embodiment 4

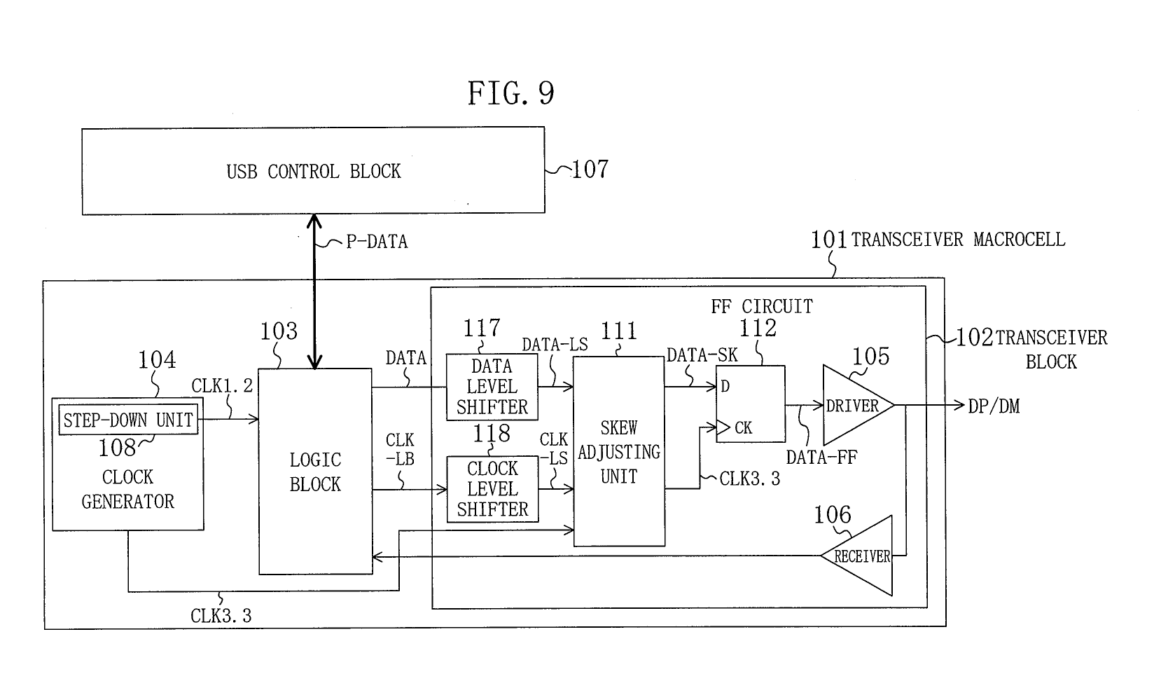

FIG. 9 is a block diagram illustrating an overall configuration of a data transmitting device according to a fourth embodiment of this disclosure.

The data transmitting device of this embodiment is different from the data transmitting device of the second embodiment illustrated in FIG. 6 only in that a clock level shifter (clock level converter) 118 is provided in the transceiver block 102. The other part of the configuration is the same as that of the second embodiment, and description thereof is omitted.

A data level shifter 117 provided in the transceiver block 102 receives a serial-data signal DATA from a logic block 103. The data level shifter 117 shifts the signal level of the serial-data signal DATA to a power supply voltage level of the transceiver block 102, and outputs the resultant serial-data signal DATA-LS to a skew adjusting unit 111.

The clock level shifter 118 in the transceiver block 102 receives a clock signal CLK-LB of the 1.2 V system used for signal processing of the logic block 103. The clock level shifter 118 shifts the signal level of the clock signal CLK-LB of the 1.2 V system to the level of a signal of the 3.3 V system which is the power supply voltage level of the transceiver block 102, and outputs the resultant clock signal CLK-LS to the skew adjusting unit 111.

Then, based on the serial-data signal DATA-LS after the level shift, the clock signal CLK-LS after the level shift, and a clock signal CLK3.3 from a clock generator 104, a delay of the serial-data signal DATA-LS is adjusted, thereby adjusting skew between the serial-data signal DATA-LS and the clock signal CLK3.3. The resultant serial-data signal DATA-SK after the delay adjustment is shaped by a FF circuit 112.

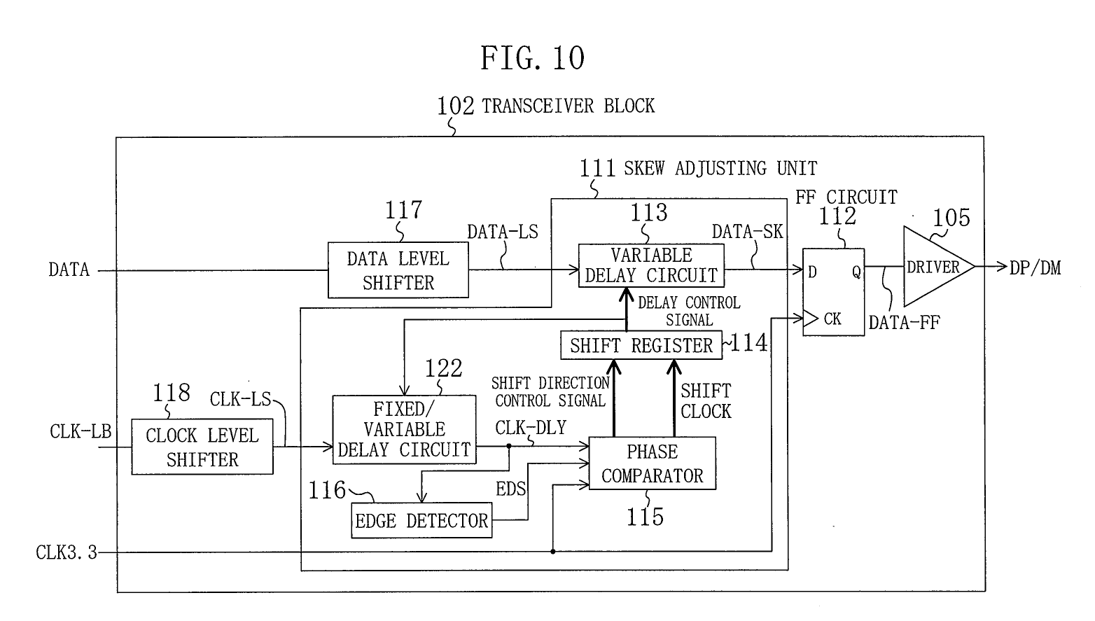

FIG. 10 is a block diagram illustrating an overall configuration of the skew adjusting unit 111 in the data transmitting device of this embodiment.

In FIG. 10, reference numeral 113 denotes a variable delay circuit (data delay circuit), reference numeral 114 denotes a shift register (delay-time storage circuit), reference numeral 115 denotes a phase comparator (delay-time adjusting circuit), reference numeral 116 denotes an edge detector (delay-start control circuit), and reference numeral 122 denotes a fixed/variable delay circuit (fixed-time delay circuit and clock delay circuit).

A delay of a clock signal CLK-LS supplied to the skew adjusting unit 111 is adjusted by the fixed/variable delay circuit 122, and the resultant clock signal CLK-DLY is supplied to the edge detector 116 and the phase comparator 115. In response to an input of an edge detection signal EDS that is output from the edge detector 116 at a rise of the clock signal CLK-DLY, the phase comparator 115 performs phase comparison between the clock signal CLK-DLY and the clock signal CLK3.3. Based on the phase relationship between these two signals CLK-DLY and CLK, a delay time of the variable delay circuit 113 for adjusting a delay of the serial-data signal DATA-LS input to the skew adjusting unit 111 is input to the shift register 114 as a shift direction control signal and a shift clock. The shift register 114 stores the delay time of the variable delay circuit 113 supplied from the phase comparator 115. By adjusting this delay time, the delay of a serial-data signal DATA-SK is adjusted, thus adjusting a delay time of a data line supplied to the FF circuit 112.

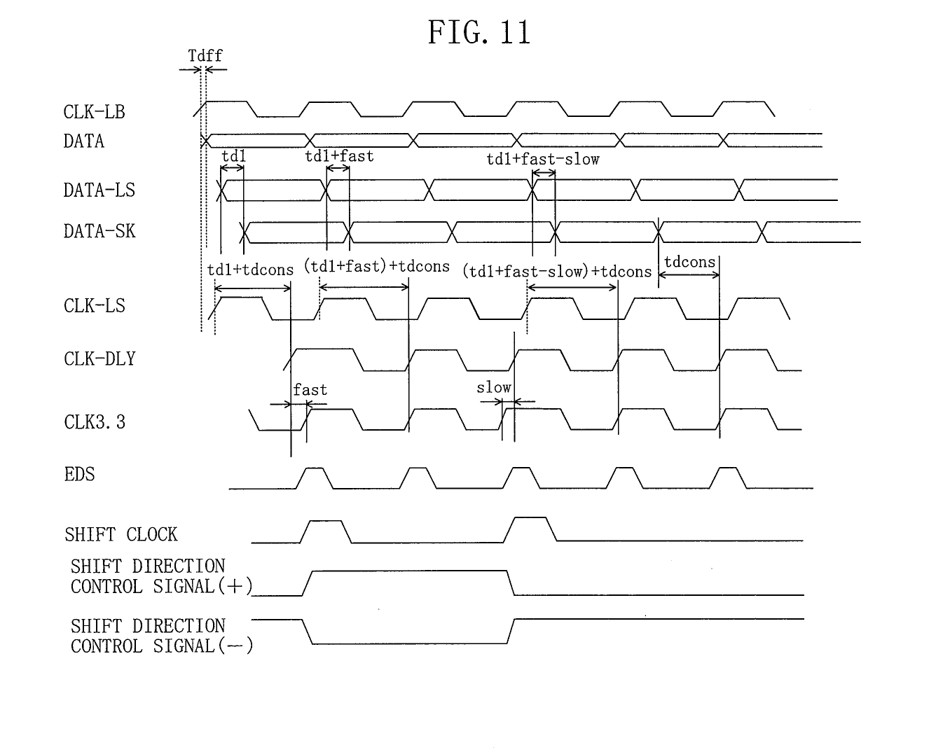

FIG. 11 is a diagram showing signal waveforms in an internal circuit of the skew adjusting unit 111.

Referring now to FIGS. 10 and 11, principles of operation of the skew adjusting unit 111 are described.

First, in the fixed/variable delay circuit 122, a delay in a variable delay amount td1 and a delay in a fixed delay amount tdcons are given to a clock signal CLK-LS, and a clock signal CLK-DLY whose delay has been adjusted is input to the edge detector 116 and the phase comparator 115.

Next, the edge detector 116 detects a rising edge of the clock signal CLK-DLY and outputs an edge detection signal EDS. The edge detection signal EDS is input to the phase comparator 115 so that the phase comparator 115 is activated.

The phase comparator 115 performs phase comparison between two signals clock signal CLK-DLY and CLK3.3 and, based on this comparison result, determines the direction of the shift register 114 and generates a shift clock. At this time, if these signals CLK-DLY and CLK3.3 are in the same phase, no shift clock is generated.

If the rising edge of the clock signal CLK-DLY is ahead of the rising edge of the clock signal CLK3.3 by a time difference fast, the delay amount of the serial-data signal DATA-LS in the variable delay circuit 113 is increased by an amount corresponding to fast and the variable delay amount in the fixed/variable delay circuit 122 is increased by an amount corresponding to fast. If the rising edge of the clock signal CLK-DLY is behind the rising edge of the clock signal CLK3.3 by a time difference slow, the delay amount in the variable delay circuit 113 is reduced by an amount corresponding to slow and the variable delay amount in the fixed/variable delay circuit 122 is reduced by an amount corresponding to slow so that the phase at the rising edge of the clock signal CLK-DLY and the phase at the rising edge of the clock signal CLK3.3 are matched.

The phases at the rising edges of the clock signal CLK-DLY and the clock signal CLK3.3 are matched by repeating the above-described comparison between these signals CLK-DLY and CLK3.3 so that the phase difference between the clock signal CLK3.3 and the serial-data signal DATA-SK input to the subsequent FF circuit 112 becomes equal to the fixed delay amount tdcons in the fixed/variable delay circuit 122. In view of this, this fixed delay amount tdcons is set at an optimum value for latching a serial data signal, thus securing the setup time of data.

As described above, in this embodiment, the data level shifter 117 and the clock level shifter 118 are provided in the transceiver block 102 so that the data level shifter 117 converts the serial-data signal DATA into the serial-data signal DATA-LS and the clock level shifter 118 converts the clock signal CLK-LB used for signal processing of the logic block 103 into the clock signal CLK-LS. The serial-data signal DATA-LS, the clock signal CLK-LS, and signals based on these signals are input to the skew adjusting unit 111 and the FF circuit 112. Accordingly, an input voltage is shifted to a desired voltage so that the signal voltage levels of signals supplied to the skew adjusting unit 111 and the FF circuit 112 are matched, resulting in facilitating skew adjustment.

In this embodiment, the data level shifter 117 and the clock level shifter 118 are provided in the transceiver block 102. Alternatively, the data level shifter 117 and the clock level shifter 118 may, of course, be provided outside the transceiver block 102, e.g., in a transceiver macrocell 101.

### Embodiment 5

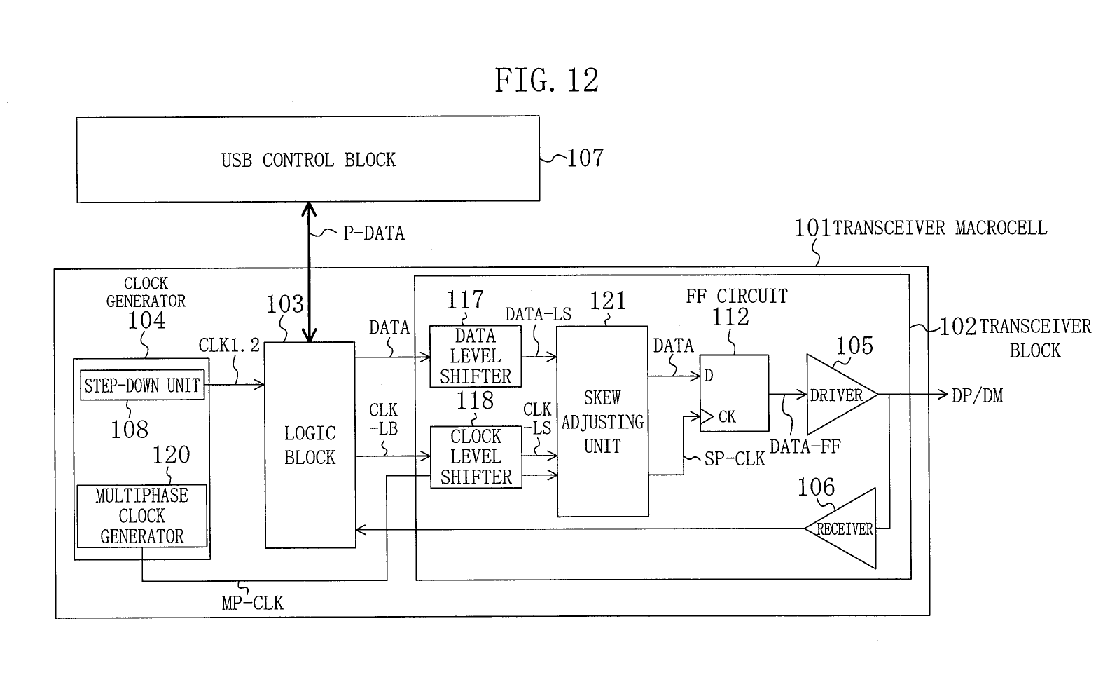

FIG. 12 is a block diagram illustrating an overall configuration of a data transmitting device according to a fifth embodiment of this disclosure.

The data transmitting device of this embodiment is different from the data transmitting device of the fourth embodiment illustrated in FIG. 9 only in that a multiphase clock generator 120 is provided in a clock generator 104 and the skew adjusting unit 111 is replaced by a skew adjusting unit 121. The other part of the configuration is the same as that of the fourth embodiment, and description thereof is omitted.

In this embodiment, multiphase clock signals MP-CLK generated by the multiphase clock generator 120 are supplied to the skew adjusting unit 121. The skew adjusting unit 121 selects a single-phase clock signal SP-CLK from the multiphase clock signals MP-CLK by using a clock signal CLK-LS to adjust skew between a serial-data signal DATA and the single-phase clock signal SP-CLK.

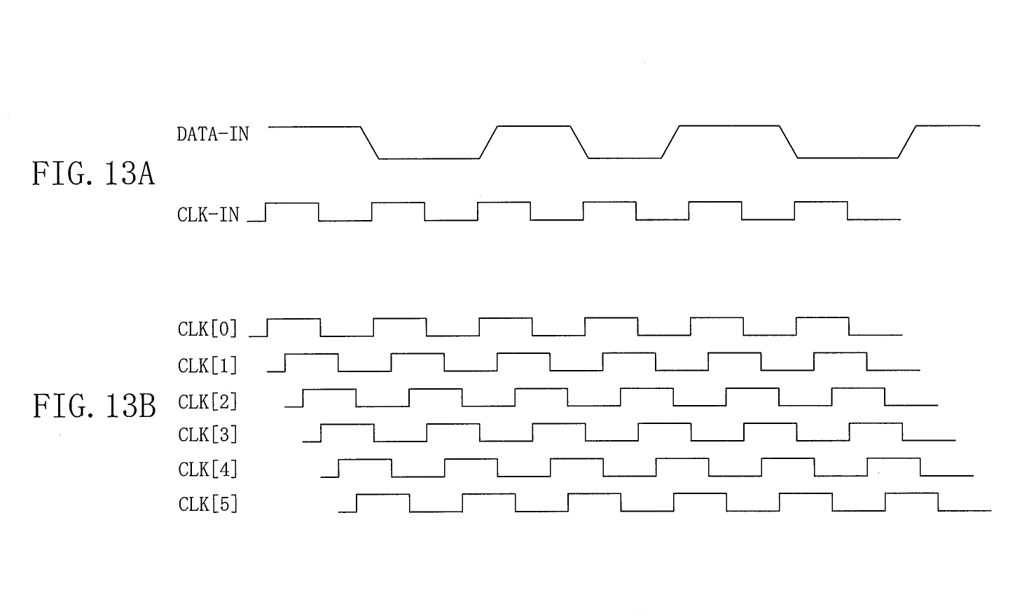

FIGS. 13(A) and 13(B) are waveform diagrams schematically showing selection of a single-phase clock signal in the skew adjusting unit 121 of this embodiment.

As shown in FIG. 13(A), the edges of a clock signal CLK-IN and the edges of a serial-data signal DATA-IN overlap each other in terms of time. Thus, in shaping the serial-data signal DATA-IN by using, for example, the clock signal CLK-IN, a FF circuit 112 cannot accurately shape a serial-data signal DATA-IN.

To accurately shape the serial-data signal DATA-IN, in this embodiment, multiphase clock signals CLK[5:0] (MP-CLK) having different phases as shown in FIG. 13(B) are supplied to the skew adjusting unit 121. Each of the phases of the multiphase clock signals CLK[5:0] is compared with the phase of the clock signal CLK-LS after a level shift by the clock level shifter 118. Based on the comparison result, one of the multiphase clock signals CLK[5:0] (i.e., the single-phase clock signal SP-CLK) is supplied to the FF circuit 112 at a subsequent stage.

The FF circuit 112 shapes the serial-data signal DATA by using the single-phase clock signal SP-CLK, and the resultant serial-data signal DATA-FF is transmitted by a driver 105.

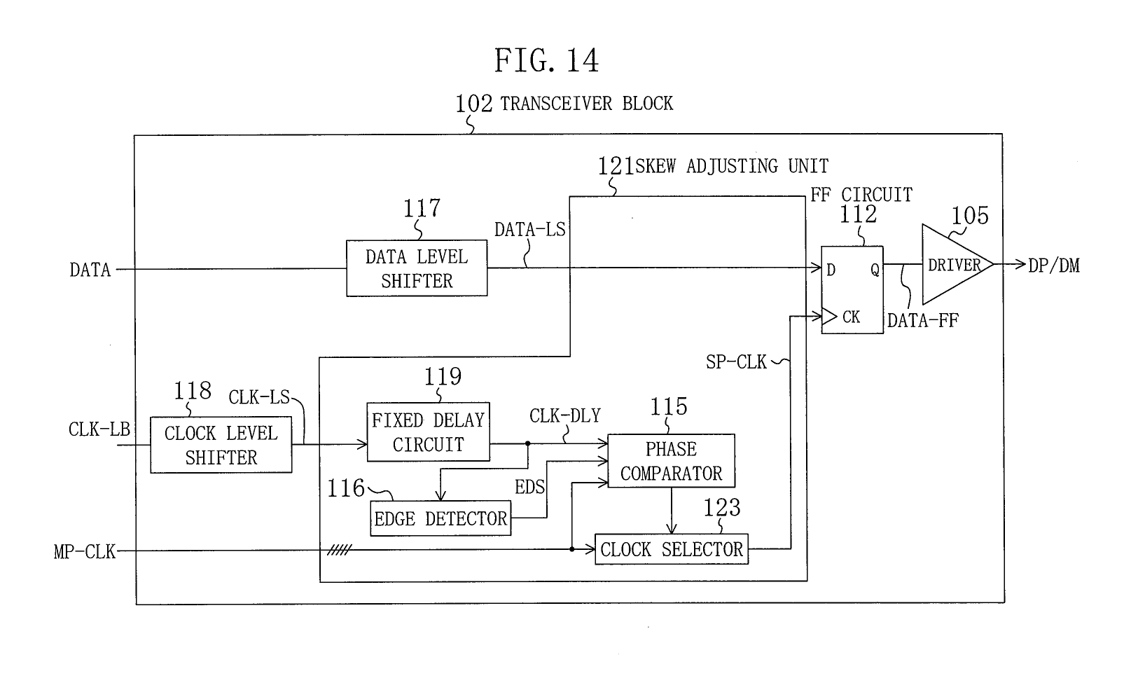

FIG. 14 is a block diagram illustrating an overall configuration of the skew adjusting unit 121 in the data transmitting device of this embodiment.

In FIG. 14, reference numeral 115 denotes a phase comparator (delay-time adjusting circuit), reference numeral 116 denotes an edge detector (delay-start control circuit), and reference numeral 123 denotes a clock selector.

A clock signal CLK-LS supplied to the skew adjusting unit 121 is subjected to delay adjustment in the fixed delay circuit 119. A clock signal CLK-DLY after the delay adjustment is supplied to the edge detector 116 and the phase comparator 115. Upon input of an edge detection signal EDS output at a rising of the clock signal CLK-DLY from the edge detector 116, the phase comparator 115 performs phase comparison between the clock signal CLK-DLY and each of the multiphase clock signals MP-CLK. Based on the comparison result in the phase comparator 115, the clock selector 123 selects a single-phase clock signal SP-CLK from the multiphase clock signals MP-CLK, and supplies the selected single-phase clock signal SP-CLK to a FF circuit 112 at a subsequent stage.

As described above, unlike the skew adjusting units 111 of the first through fourth embodiments, the skew adjusting unit 121 delays none of the serial-data signal DATA-LS, the clock signal CLK-LS, and the multiphase clock signals MP-CLK supplied to the skew adjusting unit 121 but selects a single-phase clock signal SP-CLK from the multiphase clock signals MP-CLK and supplies the selected single-phase clock signal SP-CLK to the FF circuit 112, thus adjusting skew between the serial-data signal DATA-LS and the clock signal SP-CLK to be input to the FF circuit 112.

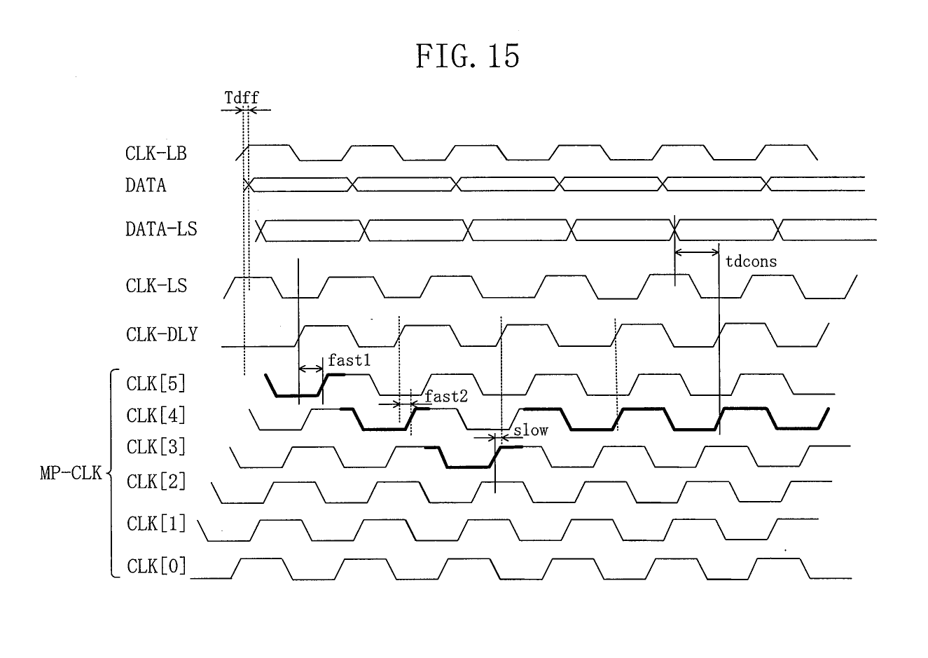

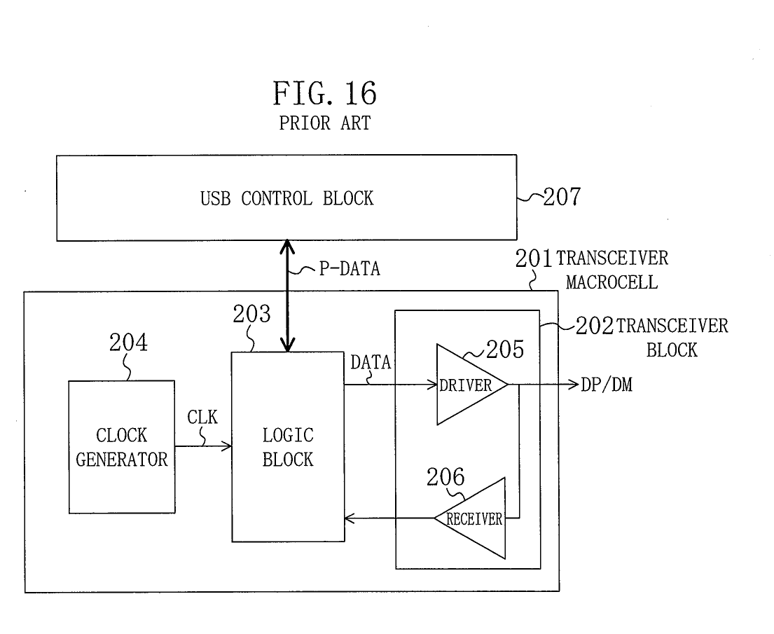

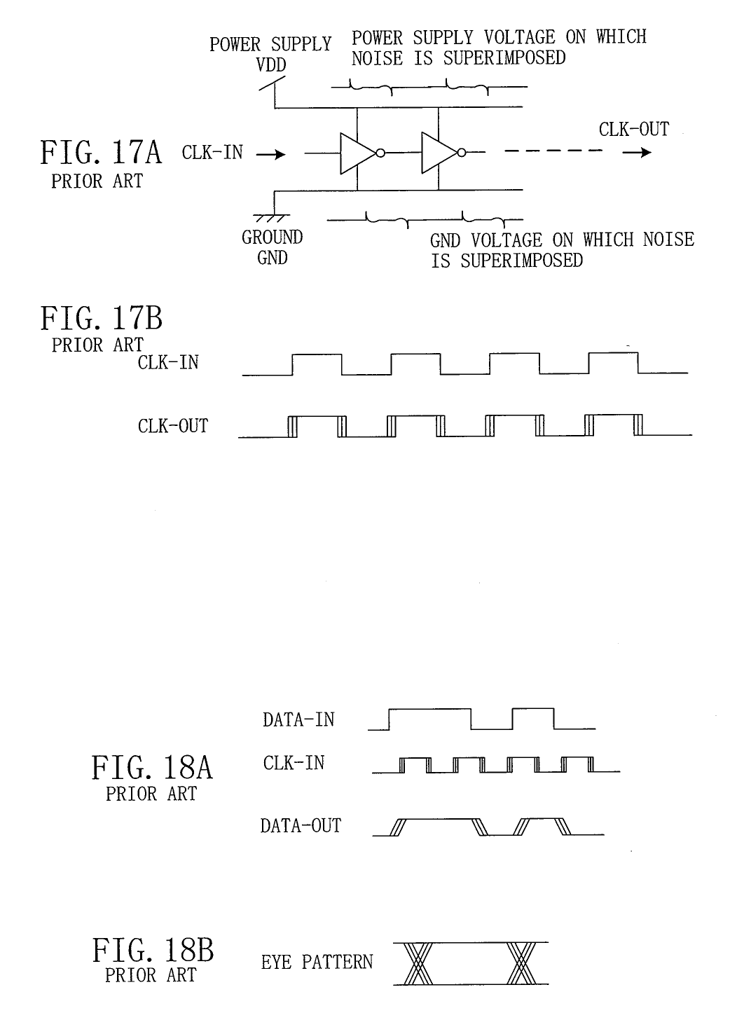

FIG. 15 is a diagram showing signal waveforms in an internal circuit of the skew adjusting unit 121.

In FIG. 15, bold lines in multiphase clock signals CLK[5:0] indicate single-phase clock signals SP-CLK.

Referring now to FIGS. 14 and 15, principles of operation of the skew adjusting unit 121 are described.

First, in a fixed delay circuit 119, a delay in a fixed delay amount tdcons is given to a clock signal CLK-LS, and the resultant clock signal CLK-DLY whose delay has been adjusted is input to the edge detector 116 and the phase comparator 115.

Next, the edge detector 116 detects a rising edge of the clock signal CLK-DLY and outputs an edge detection signal EDS. The edge detection signal EDS is input to the phase comparator 115 so that the phase comparator 115 is activated.

The phase comparator 115 performs phase comparison between a rising edge of the clock signal CLK-DLY and a rising edge of a currently-selected single-phase clock signal SP-CLK. If the rising edge of the clock signal CLK-DLY is ahead of the rising edge of the single-phase clock signal, the clock selector 123 controls clock selection such that a single-phase clock signal SP-CLK one phase earlier than the currently-selected single-phase clock signal SP-CLK is selected. If the rising edge of the clock signal CLK-DLY is behind the rising edge of the single-phase clock signal SP-CLK, the clock selector 123 controls clock selection such that a single-phase clock signal SP-CLK in one phase later than the currently-selected single-phase clock signal SP-CLK is selected. By repeatedly performing the foregoing selection of a single-phase clock signal, a single-phase clock signal SP-CLK is selected from the multiphase clock signals MP-CLK such that the phase of the clock signal CLK-DLY and the phase of the selected single-phase clock signal SP-CLK match each other. At this time, if the phase of the clock signal CLK-DLY and the phase of the single-phase clock signal SP-CLK already match each other, the clock switching described above is not performed.

As described above, comparison between the clock signal CLK-DLY and the single-phase clock signal SP-CLK is repeatedly performed such that the phase of the clock signal CLK-DLY and the phase of the single-phase clock signal SP-CLK match each other. Accordingly, a phase difference between the single-phase clock signal SP-CLK and the serial-data signal DATA-LS input to the FF circuit 112 at a subsequent stage becomes equal to a fixed delay amount tdcons. This fixed delay amount tdcons is set at an optimum value for latching a serial data signal, thus securing the setup time of data.

As described above, in this embodiment, the multiphase clock generator 120 is provided to generate multiphase clock signals MP-CLK whose phases differ at regular intervals. Thus, the timings of the serial-data signal DATA and the single-phase clock signal SP-CLK input to the FF circuit 112 are adjusted, thereby ensuring synchronization between these signals DATA and SP-CLK.

In this embodiment, a single-phase clock signal SP-CLK is selected from the multiphase clock signals MP-CLK based on the serial-data signal DATA and the clock signal CLK-LB used for signal processing of the logic block 103. Alternatively, the single-phase clock signal SP-CLK may, of course, be selected based on the serial-data signal DATA, for example.

The skew adjusting unit 121 of this embodiment selects a single-phase clock signal SP-CLK from the multiphase clock signals MP-CLK by using the clock signal CLK-LS. Alternatively, the single-phase clock signal SP-CLK may, of course, be selected by using the serial-data signal DATA-LS, for example.

The single-phase clock signal SP-CLK may also be selected by detecting and using a phase difference between two clock signals CLK-LB and CLK-LS between before and after a level shift in the clock level shifter 118.

A data transmitting device according to this disclosure described above can be implemented by employing a data synchronization function of synchronizing a processed data signal to a high-quality clock signal having low jitter, in addition to a function of data transmission conforming to standards of high-speed interfaces such as USB 2.0 and Serial ATA.

The data transmitting devices of the first through fifth embodiments conform to interface standards such as the USB 2.0 standard and the Serial ATA standard, and data signals transmitted to outside the devices are referred to as differential signals. However, a data transmitting device according to this disclosure is not limited to this, of course.

### INDUSTRIAL APPLICABILITY

As described above, this disclosure enables generation of a data signal conforming to transmission standards by shaping a data signal whose signal quality has deteriorated and, therefore, is useful especially for data transmitting devices conforming to the USB and Serial ATA standards.

1. A data transmitting device, characterized by comprising:
a clock generator for generating a clock signal;
a logic block for performing signal processing on a received input data signal by using the clock signal, thereby generating a processed data signal;
a data driver for outputting the processed data signal to a transmission system,
wherein the data driver includes:
a skew adjusting unit for receiving the clock signal and the processed data signal, and adjusting skew between the clock signal and the processed data signal based on a phase relationship between these signals;
a flip-flop circuit for shaping the processed data signal from the skew adjusting unit by using the clock signal from the skew adjusting unit.

2. The data transmitting device of claim 1, characterized in that the skew adjusting unit receives the clock signal used for the signal processing of the logic block and, based on this clock signal, adjusts skew between the clock signal and the processed data signal.

3. The data transmitting device of one of claims 1 and 2, characterized by further including a data level converter for converting a signal level of the processed data signal from the logic block into a power supply voltage level of the data driver.

4. The data transmitting device of one of claims 1 to 3, characterized by further including a clock level converter for converting a signal level of the clock signal used for the signal processing of the logic block into a power supply voltage level of the data driver.

5. The data transmitting device of one of claims 1 to 4, characterized in that the skew adjusting unit includes a data delay circuit for delaying the processed data signal from the logic block.

6. The data transmitting device of one of claims 1 to 4, characterized in that the skew adjusting unit includes a clock delay circuit for delaying the clock signal from the clock generator.

7. The data transmitting device of one of claims 5 and 6, characterized in that the skew adjusting unit includes a delay-time adjusting circuit for adjusting a delay time of at least one of the data delay circuit and the clock delay circuit, and
the delay-time adjusting circuit adjusts the delay time of at least one of the data delay circuit and the clock delay circuit based on a phase relationship between the processed data signal from the logic block and the clock signal from the clock generator.

8. The data transmitting device of one of claims 5 and 6, characterized in that the skew adjusting unit includes a delay-time adjusting circuit for adjusting a delay time of at least one of the data delay circuit and the clock delay circuit, and
the delay-time adjusting circuit adjusts the delay time of at least one of the data delay circuit and the clock delay circuit based on a phase relationship among the processed data signal from the logic block, the clock signal from the clock generator, and the clock signal used for the signal processing of the logic block.

9. The data transmitting device of one of claims 7 and 8, characterized in that the skew adjusting unit includes a delay-start control circuit for controlling a start of the delay time adjustment by the delay-time adjusting circuit.

10. The data transmitting device of one of claims 7 to 9, characterized in that the skew adjusting unit includes a delay-time storage circuit for storing an amount of adjustment of the delay time by the delay-time adjusting circuit.

11. The data transmitting device of one of claims 7 to 10, characterized in that the skew adjusting unit includes a fixed-time delay circuit for delaying, by a given time, the adjustment of the delay time by the delay-time adjusting circuit.

12. The data transmitting device of claim 1, characterized in that the clock generator includes a multiphase clock generator for generating multiphase clock signals,
the skew adjusting unit selects a single-phase clock signal from the multiphase clock signals based on the processed data signal from the logic block, and
the flip-flop circuit shapes the processed data signal from the skew adjusting unit by using the single-phase clock signal.

13. The data transmitting device of claim 2, characterized in that the clock generator includes a multiphase clock generator for generating multiphase clock signals,
the skew adjusting unit selects a single-phase clock signal from the multiphase clock signals based on the processed data signal from the logic block and the clock signal used for the signal processing of the logic block, and
the flip-flop circuit shapes the processed data signal from the skew adjusting unit by using the single-phase clock signal.

14. A data transmitting method, characterized by comprising:
a clock generation step of generating a clock signal;
a data signal processing step of performing signal processing on a received input data signal by using the clock signal and of generating a processed data signal;
a skew adjustment step of adjusting skew between the clock signal and the processed data signal based on a phase relationship between these signals;
a data processing step of shaping the processed data signal in the skew adjustment step by using the clock signal in the skew adjustment step; and
a data drive step of outputting the processed data signal shaped in the data processing step to a transmission system.
